(19) United States
(12) Patent Application Publication
(10) Pub. No.: US 2007/0019854 A1
(43) Pub. Date: Jan. 25, 2007

(54) Method and system for automated digital image analysis of prostrate neoplasms using morphologic patterns

(75) Inventors: Abhijeet S. Gholap, Pune (IN); Gauri A. Naik, Pune (IN); Aparna Joshi, Pune (IN); Satyakam Sawaimoon, New Mumbai (IN); Chivate Sujit Siddheshwar, Pune (IN); Prithviraj Jadhav, Pune (IN); C. V. K. Rao, Pune (IN)

Correspondence Address: Lesavich High-Tech Law Group, P.C., Suite 325, 39 S. LaSalle Street, Chicago, IL, 60603, US

(73) Assignee: Bioimagene, Inc., Cupertino, CA (US)

(21) Appl. No.: 11/431,786

(22) Filed: May 10, 2006

Related U.S. Application Data
(60) Provisional application No. 60/679,449, filed on May 10, 2005.

(51) Int. Cl. G06K 9/00

(52) U.S. Cl. 382/133; 128/922

(57) ABSTRACT

A method and system method and system automated digital image analysis of prostrate neoplasms using morphologic patterns. The method and system provide automated screening of prostate needle biopsy specimens in a digital image and automated diagnosis of prostatectomy specimens.

### CROSS REFERENCES TO RELATED APPLICATIONS

This application claims priority to U.S. Provisional Patent Application No. 60/679,449, filed May 10, 2005, and U.S. patent application Ser. No. 11/361,774, filed Feb. 23, 2006, which claims priority to U.S. Provisional Patent Application No. 60/655,465, filed Feb. 23, 2005, the contents of all of which are incorporated by reference.

### COPYRIGHT NOTICE

Pursuant to 37 C.F.R. 1.71(e), applicants note that a portion of this disclosure contains material that is subject to and for which is claimed copyright protection, such as, but not limited to, digital photographs, screen shots, user interfaces, or any other aspects of this submission for which copyright protection is or may be available in any jurisdiction. The copyright owner has no objection to the facsimile reproduction by anyone of the patent document or patent disclosure, as it appears in the U.S. Patent Office patent file or records. All other rights are reserved, and all other reproduction, distribution, creation of derivative works based on the contents of the application or any part thereof are prohibited by applicable copyright law.

### FIELD OF THE INVENTION

This invention relates to digital image processing. More specifically, it relates to a method and system for automated digital image analysis of prostrate neoplasms using morphologic patterns.

### BACKGROUND OF THE INVENTION

Prostate cancer is one of the most frequently diagnosed non-skin cancer in men in the United States, but is a distant second to lung cancer as a cause of death. In 1997, the estimated number of new cases of prostate cancer was 209,900, and the estimated number of deaths from this disease is 41,800. (See http://www.bccancer.bc.ca/HPI/CancerManagementGuidelines/Genitourinary/Prostate/PSAScreening/ProstateCancerIncidenceandMortalityinBC.htm)

Prostate cancer (i.e., prostate adenocarcinoma) has become an important concern in terms of public health these past fifteen years internationally as well. A recent French epidemiological study revealed 10,104 deaths due to this disease in 2000 (See Fournier G, Valeri A, Mangin P, Cussenot O. Prostate cancer: Epidemiology, Risk factors, Pathology. Ann Urol (Paris). 2004 October; 38(5):187-206).

In 2001, there were 30,142 new cases of prostate cancer diagnosed in the UK (See http://info.cancerresearchuk.org/cancerstats/prostate/incidence/). The American Cancer Society (ACS) estimates that about 230,900 new cases will be diagnosed in 2004 and about 29,900 men will die of the disease. (See http://urologychannel.com/prostate/cancer/index.shtml). A little-known fact is that a man is 33% more likely to develop prostate cancer than an American woman is to get breast cancer. (See www.prostatecancerfoundation.org). Prostate cancer strikes as many men (and causes almost as many deaths annually) as breast cancer does in women, but lacks the national awareness and research funding breast cancer currently receives.

Screening is considered useful when there is evidence that treatment at an earlier stage of disease will result in fewer overall deaths or reduce the need for aggressive treatment. $15.5 million is appropriated to prostate cancer activities in fiscal year 2004. (See http://www.cdc.gov/cancer/prostate/about2004.htm) The Centers for Disease Control and Prevention (CDC) is conducting research and other activities related to prostate cancer screening.

Prostate Cancer screening program: includes,

Detection of serum PSA levels,

Digital Rectal Exam (DRE), and

Prostate biopsy (tissue exam).

According to the American Cancer Society, men aged 50 and older, and those over the age of 45 who are in high-risk groups, such as African-American men and men with a family history of prostate cancer, should have a prostate-specific antigen (PSA) blood test and digital rectal exam (DRE) once every year.

In an article “Normal Histology of the prostate”, McNeal J E has described key details of the prostate gland. The prostate gland contains three major glandular regions—the peripheral zone, the central zone, and the transition zone—which differ histologically and biologically. The central zone is relatively resistant to carcinoma and other disease; the transition zone is the main site of origin of prostate hyperplasia. There are also several important nonglandular regions concentrated in the anteromedial portion of the gland. Each glandular zone has specific architectural and stromal features. In all zones, both ducts and acini are lined by secretory epithelium. In each zone, there is a layer of basal cells beneath the secretory lining, as well as interspersed endocrine-paracrine cells. Frequent deviations from normal histology include post-inflammatory atrophy, basal cell hyperplasia, benign nodular hyperplasia, atypical adenomatous hyperplasia, and duct-acinar dysplasia. These lesions may at times be confused with carcinoma, especially in biopsy material.

As is known in the medical arts, “neoplasms” are new abnormal growth of tissue. Malignant neoplasms show a greater degree of anaplasia and have the properties of invasion and metastasis, compared to benign neoplasms. In screening pathologists look at as many areas as possible such that they do not miss even the smallest area of malignancy. They never give report of benign or malignant on a single prostate tissue image. In our research, prostate needle biopsy images of low-power, 4× or 5× are considered. At least 72 images from various areas of the different tissue bits of a single patient are captured for analysis. Minimum 8 tissue bits will be collected from each patient. Two tissue bits will be processed together. At least, three tissue sections are taken on a single glass slide. In other words, there will be four slides per patient; each having six sections and each section is captured as three images of 1000×600 pixels. A total of 128 images are captured per patient.

A set of tissue bits collected from a patient are examined for the possibility of following three types of diseases:
Benign Prostatic Hyperplasia (BPH)—also called as Benign Hyperplasia of Prostate (BHP)—a benign condition,
Prostatitis—an infective condition,
Prostate cancer/prostate adenocarcinoma—a malignant condition.

A high level of PSA in the bloodstream is a warning sign that prostate cancer may be present. But since other kinds of prostate disease can also cause high PSA levels, PSA testing by itself cannot confirm the presence of prostate cancer. Conversely, a low PSA level does not always mean that prostate cancer is not present.

Digital rectal exam (DRE) is a cost effective way to determine whether the prostate is enlarged or has lumps or other types of abnormal texture. But, there are many causes of enlargement of Prostate gland; e.g. Benign Hyperplasia of Prostate, post-atrophic hyperplasia, atypical adenomatous hyperplasia; and inflammatory processes like granulomatous prostatitis, xanthogranulomatous prostatitis, etc. Moreover, the diagnosis of prostatic adenocarcinoma, especially when present in small amounts, is often challenging. So, the anatomopathology is a key for the diagnosis or in other words, “Tissue diagnosis is a gold standard in diagnosing prostate cancer.”

Only a biopsy can definitely confirm prostate cancer. Typically, the physician takes multiple tissue samples for biopsy. Instead of doing the classic right and left prostate biopsies and put them into two specimen jars, more and more urologists are now using 12 jars for multiple cores (or at least greater than 8 biopsy cores). This new approach, so-called ‘extended prostate biopsy procedure’, improved the cancer detection rate and many cancers can be detected earlier. But, it adds more work to histopathologists in the usual manual screening of those slides.

Thus, it is desirable to provide a method and system automated digital image analysis of prostrate neoplasms using morphologic patterns.

### SUMMARY OF THE INVENTION

In accordance with preferred embodiments of the present invention, some of the problems associated with automated biological sample analysis systems are overcome. A method and system method and system automated digital image analysis of prostrate neoplasms using morphologic patterns is presented.

The method and system provide automated screening of prostate needle biopsy specimens in a digital image and automated diagnosis of prostatectomy specimens.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary automated biological sample analysis processing system;

FIG. 2 is a flow diagram illustrating an exemplary method for automated biological sample analysis;

FIG. 3 is a flow diagram illustrating a method for automated digital image analysis of prostrate neoplasms using morphologic patterns;

FIGS. 4A and 4B a flow diagram illustrating a method for removing color masks in a digital image;

FIG. 5 is a flow diagram illustrating a method for lumen segmentation in a digital image;

FIG. 6 is a flow diagram illustrating a method for cell segmentation in a digital image;

FIG. 7 is a flow diagram illustrating a method for cytoplasmic segmentation in a digital image;

FIG. 8 is a flow diagram illustrating a method for segmentation lumen gland in a digital image;

FIG. 9 is a flow diagram illustrating a method for segmentation lumen gland in a digital image;

FIG. 10 is a flow diagram illustrating a method for segmentation non-lumen glands in a digital image;

FIG. 11 is a block diagram illustrating plural digital images corresponding to a benign tissue bit;

FIG. 12 is a block diagram illustrating plural digital images corresponding to a malignant tissue bit;

FIGS. 13A-13E are plural block diagrams illustrating plural frequency distributions to analyze clustering;

FIG. 14 is a flow diagram illustrating a method for automated digital image analysis of prostrate neoplasms using morphologic patterns;

FIG. 15 is a flow diagram illustrating a method for back propagation training;

FIG. 16 is a flow diagram illustrating a method for a training cycle; and

FIG. 17 is a flow diagram illustrating a method for back propagation recognition.

### DETAILED DESCRIPTION OF THE INVENTION

Exemplary Biological Sample Analysis System

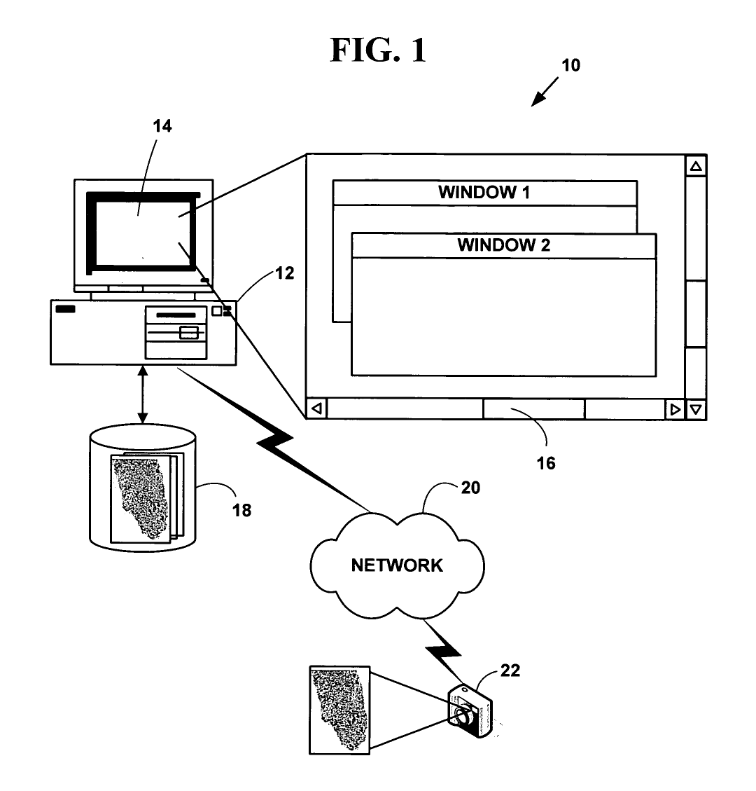

FIG. 1 is a block diagram illustrating an exemplary biological sample analysis processing system 10. The exemplary biological sample analysis processing system 10 includes one or more computers 12 with a computer display 14 (one of which is illustrated). The computer display 14 presents a windowed graphical user interface (“GUI”) 16 with multiple windows to a user. The present invention may optionally include a microscope or other magnifying device (not illustrated in FIG. 1) and/or a digital camera 18 or analog camera. One or more databases 20 (one or which is illustrated) include biological sample information in various digital images or digital data formats. The databases 20 may be integral to a memory system on the computer 12 or in secondary storage such as a hard disk, floppy disk, optical disk, or other non-volatile mass storage devices. The computer 12 and the databases 20 may also be connected to an accessible via one or more communications networks 22.

The one or more computers 12 may be replaced with client terminals in communications with one or more servers, or with personal digital/data assistants (PDA), laptop computers, mobile computers, Internet appliances, one or two-way pagers, mobile phones, or other similar desktop, mobile or hand-held electronic devices.

The communications network 22 includes, but is not limited to, the Internet, an intranet, a wired Local Area Network (LAN), a wireless LAN (WiLAN), a Wide Area Network (WAN), a Metropolitan Area Network (MAN), Public Switched Telephone Network (PSTN) and other types of communications networks 22.

The communications network 22 may include one or more gateways, routers, or bridges. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another.

The communications network 22 may include one or more servers and one or more web-sites accessible by users to send and receive information useable by the one or more computers 12. The one ore more servers, may also include one or more associated databases for storing electronic information.

The communications network 22 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is know in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 20 and the present invention is not limited to TCP/UDP/IP.

The one or more database 20 include plural digital images of biological samples taken with a camera such as a digital camera and stored in a variety of digital image formats including, bit-mapped, joint pictures expert group (JPEG), graphics interchange format (GIF), etc. However, the present invention is not limited to these digital image formats and other digital image or digital data formats can also be used to practice the invention.

The digital images are typically obtained by magnifying the biological samples with a microscope or other magnifying device and capturing a digital image of the magnified biological sample (e.g., groupings of plural magnified cells, etc.) with a camera (e.g., digital camera 18).

The term “sample” includes, but is not limited to, cellular material derived from a biological organism. Such samples include but are not limited to hair, skin samples, tissue samples, cultured cells, cultured cell media, and biological fluids. The term “tissue” refers to a mass of connected cells (e.g., central nervous system (CNS) tissue, neural tissue, or eye tissue) derived from a human or other animal and includes the connecting material and the liquid material in association with the cells. The term “biological fluid” refers to liquid material derived from a human or other animal. Such biological fluids include, but are not limited to, blood, plasma, serum, serum derivatives, bile, phlegm, saliva, sweat, amniotic fluid, and cerebrospinal fluid (CSF), such as lumbar or ventricular CSF. The term “sample” also includes media containing isolated cells. The quantity of sample required to obtain a reaction may be determined by one skilled in the art by standard laboratory techniques. The optimal quantity of sample may be determined by serial dilution. The term “neoplasm” refers to abnormal growth of a tissue.

An operating environment for the devices biological sample analysis processing system 10 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals by the CPU or processor. An electrical system represents data bits which cause a resulting transformation or reduction of the electrical signals or biological signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

Gleason Grading System in Prostate Cancer

As is known in the medical arts, the Gleason grading system evaluates an architecture (i.e., pattern) of prostate cancer. Both the primary (i.e., predominant) and secondary (i.e., second most prevalent) patterns are identified and assigned a number from one to five with one being the most differentiated and five the least differentiated. If a tumor has only one histologic pattern then the primary and secondary patterns are given the same number. For example, a tumor with mostly pattern three and a minor component of pattern four would be assigned a Gleason score of seven (3+4=7 Gleason sum=7).

Gleason pattern 1: Gleason pattern 1 is a tumor composed of a circumscribed nodule of uniform single, separate, closely packed glands. If a needle is stuck into a low grade tumor (Gleason score 1+1=2; 1+2=3; 2+1=3; 2+2=4; i.e. Gleason sum 2 through 4) there will be a lot of closely packed neoplastic glands on the biopsy without intervening benign prostate glands.

Higher magnification of Gleason sum 2-4 adenocarcinoma on needle biopsy consisting of closely packed, open, uniform, pale staining glands. Glands tend to have even luminal surfaces. Numerous crystalloids are seen which are more frequently seen in low grade adenocarcinomas.

Gleason pattern 2: It consists of uniform, large, open, pale staining glands with somewhat more separation than Gleason pattern 1. However, the tumor does not infiltrate widely in and amongst benign prostate glands. Again, a needle biopsy of Gleason pattern 2 tumor will show numerous open pale staining glands of large size without intervening and admixed benign prostate glands.

Gleason pattern 3: Glands are much smaller than low grade cancer. The glands infiltrate in and amongst benign prostate glands. These features distinguish it from low grade adenocarcinoma. The glands, even at medium to low magnification consist of single, separate, circular units which is typical of Gleason pattern 3 in contrast to fused glandular units seen in Gleason pattern 4.

Numerous small glands are seen infiltrating in between benign prostate glands characterized by large size with papillary infolding. The neoplastic glands are smaller and more infiltrating than is seen in Gleason pattern 2. The glands are composed of single, separate, glandular units in contrast to Gleason pattern 4. One can mentally draw a circle around most of the glandular units as discrete units in contrast to the fused appearance and ill-defined glandular appearance of Gleason pattern 4.

Although there are only a few neoplastic glands, the fact that they are small and situated in an infiltrative pattern between benign glands is diagnostic of Gleason pattern 3.

Gleason pattern 4: It consists of a large mass of cribriform glands. When the nodule of the cribriform glands is bigger than that of a normal prostate gland, that is Gleason pattern 4.

In Gleason pattern 4, the cribriform glands are more irregular and ragged at the edge. Also, when the cribriform glands are not as well developed, lacking punched out round holes, it is more typical of Gleason pattern 4. The cribriform glands are also too large to be that of Gleason cribriform pattern 3. However, there are no discrete circular individual glandular units as seen in Gleason pattern 3. Fused Cribriform glands is distinguishing feature of pattern 4.

Gleason pattern 5: Sheets of cells typical of Gleason pattern 5. Cords of cells without glandular differentiation consistent with Gleason pattern 5.

Automated Methods for Digital Image Analysis of Prostrate Neoplasms Using Morphologic Patterns

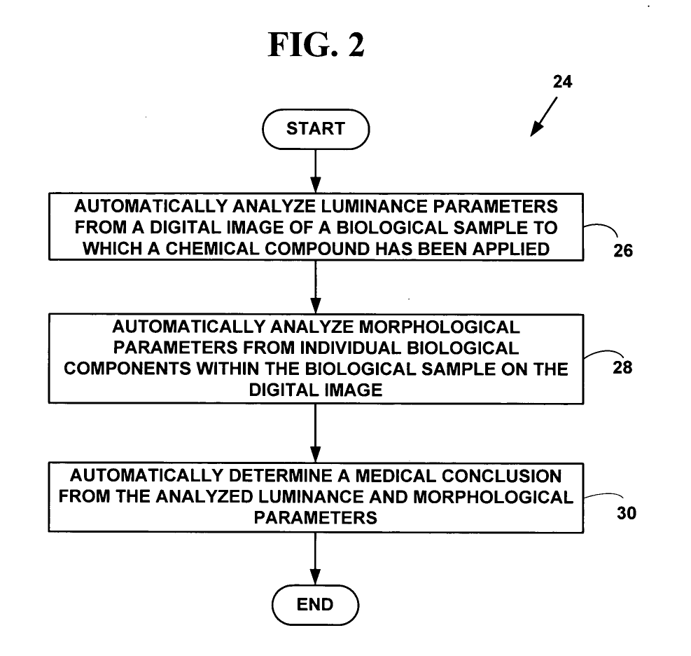

FIG. 2 is a flow diagram illustrating an exemplary Method 24 for automated biological sample analysis. At Step 26, predetermined parameters from a digital image of a biological sample to which a chemical compound has been applied are modified to make a set of plural biological objects in the digital image more distinct. At Step 28, plural biological objects of interest are located in the set of plural biological objects made more distinct. At Step 30, the located biological objects of interest are identified and classified to determine a medical diagnosis conclusion.

In one embodiment, Method 24 is used for automated analysis of tissues potentially including human prostate cancers.

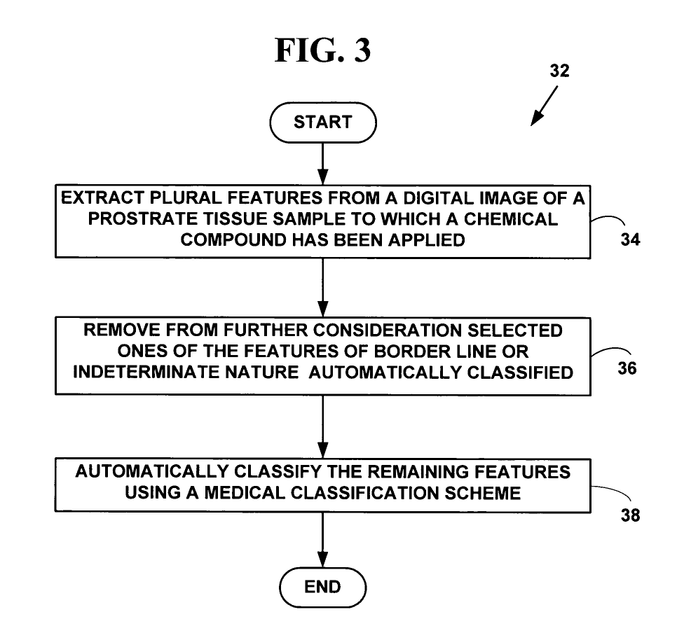

FIG. 3 is a flow diagram illustrating a Method 32 for automated digital image analysis of prostrate neoplasms using morphologic patterns. At Step 34, plural features are extracted from a digital image of a prostrate tissue sample to which a chemical compound has been applied. At Step 36, selected ones of the features on a border line or of an indeterminate nature are automatically classified are removed from further consideration. At Step 38, the remaining features are automatically classified using a medical classification scheme to determine a medical classification for prostrate tissue sample.

Method 32 is illustrated with one exemplary embodiment. However, the present invention is not limited to this exemplary embodiment and other embodiments can also be used to practice the invention.

In such an exemplary embodiment, at Step 34, plural features are extracted from each field of view of digital image of tissue bits to which a H/E stain has been applied. For example, the plural features include, but are not limited to, gland size, shape, arrangement and destruction, stroma area and Lymphocytes presence. However, the present invention is not limited to the plural features listed and other features can also be extracted. Table 1 illustrates an exemplary protocol used to extract the plural features at Step 34. However, the present invention is not limited to this protocol and other protocols can also be used to practice the invention.

TABLE 1

| | Feature | Benign | Malignant |
|---|---|---|---|
| 1 | Glands size | More or less equal | Varying |
| 2 | Glands shapes | More or less similar | Varying |
| 3 | Glands arrangement | Loose with intervening | Compact, back-to-back |
| | | stroma | |
| 4 | Glands destruction | Present in prostatitis | Absent |
| 5 | Stroma | Abundant | Less |
| 6 | Lymphocytes | Present | Absent (High grade Gl |
| | | | mimics) |

At Step 36, tissue images of border line or indeterminate nature are automatically classified and removed from further consideration. In one embodiment, tissue images comprising non-malignant cells and cytoplasm are removed from the plural features extracted at Step 34.

In one embodiment, tissue images of a medical classification border line or indeterminate nature are automatically classified. In one embodiment, the automatic classifications are automatically reviewed. In another embodiment, automatic classifications are manually peer reviewed. In one embodiment, peer review makes use of patient's age, DRE and PSA reports and clinical findings in arriving at a conclusion. Table 2 illustrates exemplary parameters used for peer review. However, the present invention is not limited to this protocol and other protocols can also be used to practice the invention.

TABLE 2

| | Parameter | Benign | Malignant |
|---|---|---|---|
| 1 | Age | 6^{th} decade | 7^{th} decade |
| 2 | Clinical Findings | Pain negative | Pain positive |
| 3 | DRE report | Smooth surface | Irregular surface |
| 4 | PSA | Mild- moderate increase | Marked increase |

At Step 38, remaining features are automatically classified using a medical classification scheme. At this step, only potential malignant features are left, which are classified using a Gleason's grade and score. There is considerable interobserver discordance in distinguishing Gleason score, more frequently among biopsy specimens, and more so with lower tumor volumes, particularly among those with less than 30% involvement. As a result, automated Step 38 improves Gleason grading and scoring.

In one embodiment, Hematoxillin and Eosin (H/E) method of staining is used to study the morphology of tissue samples. Based on the differences and variations in the patterns from the normal tissue, the type of cancer is determined. Also the pathological grading or staging of cancer (e.g., Gleason Method) is determined using the H/E staining. This pathological grading of cancer is not only important from diagnosis angle but has prognosis value attached to it. For example, using H/E staining, cell membranes stain brown and other cell components stain blue so red and blue color planes are used.

It is also known that objects in areas of interest, such as cancer cells, cell nuclei are blue in color when stained with H/E staining. However, if a biological tissue sample when treated with other than H/E staining, then nuclei or other cell components may appear as a different color other than blue and pixels would be eliminated using other than color planes described herein.

In one embodiment, closer observation of Tables 1 and 2 illustrates that an automated conclusion is based on several quantifiable factors and few qualitative factors. A deterministic approach to analyze measurable parameters and fuzzy logic based decision support system for qualitative parameters. It is known that terms used in Table 1 like, Variation in glands size can be estimated using standard statistical methods. There are other terms like “abundant/less” which are subjective in nature. Human pathologists learn the significance of these terms during training based on number of examples. Counter part similar to the way human pathologist learns in technology world is known as neural networks mimicking neurons in human brain and fuzzy logic to explain the flexibility and adoptability in decision making process of human beings.

In one embodiment, for example, digital images of Prostate needle biopsy of low-power (4× or 5×) are considered for analysis. Digital images captured through optical microscopes represent the images seen by a human eye through the microscope. However, a pathologist can easily identify and distinguish between various components in a tissue bit like lining epithelial cell, gland area, epithelial cell and lymphocytes, even though there are variations in staining, variations in illumination across a slide or the presence of a mask or an artifact. This is because of experience and knowledge of the pathologist in the pathology domain. In one embodiment, pre-processing of the digital images achieve the same objective, namely reducing the effect of variations in staining intensity, effect of colored mask and other anomalies.

Quality of an input image is assessed in arriving at a conclusion on the presence of mask, contrast enhancement and rejection of input image. If the sharpness parameter value for one or more color planes is more than 100 and the standard deviation in gray scale value of pixels is less than 25 or 10% of the range then contrast enhancement is done. An input image is rejected if the sharpness parameter value of each color plane is less than 100 and the standard deviation in gray scale value of pixels is less than 25 or 10% of the range.

There are at least three different strategies followed in current invention for Method 32:

Deterministic approach in processing quantifiable measurements

Fuzzy logic to process semi quantifiable terms

Neural network based approach to learn Gleason score from examples

At Step 34, an input image is put through a sequence of deterministic steps for measuring Glands size variation, Glands shape variation, Glands arrangement factor, Glands destruction factor, Stroma area and presence of lymphocytes. Digital images of Prostate needle biopsy of low-power (4× or 5×) are considered for analysis.

Mask or Artifact Removal: It is observed that represent a color mask or artifact in a background in an image of biological specimen can be represented by determining a mean of pixel values. In one embodiment, By mapping this mean pixel value to the mid value of pixel values range, mask removal effects can be achieved normalization of background to a standard value can be achieved. In one embodiment, this standard value for mean is made (R1,G1,B1) (e.g., R1=128 for red color, G1=128 for green color and B1=128 for blue color). However, the present invention is not limited to this embodiment and other standard values can be used to practice the invention.

In a given image pixels having intensity less than the mean are mapped into new pixel value using the formula given in Equation (1).
R′(x,y)=(R(x,y)*Con1)/Rₘₑₐₙ, (1)
where R(x,y) is the red color component value at point x,y in the image, R′(x,y) is the modified value for the red color component and Rₘₑₐₙ is the mean pixel value of red color plane and Con1 is a constant (e.g., 128, etc.). Similar equations are used for green and blue color components.

If the given pixel value is greater than the mean, then the pixel value is modified using the formula given in Equation (2).
R′(x,y)=((2*R(x,y)−Rₘₑₐₙ)*Con2)/R(x,y), (2)
where R(x,y) is a red color component value at point x,y in the image, R′(x,y) is a modified value for the red color component and Rₘₑₐₙ is a mean pixel value of red color plane and Con2 is a constant (e.g., 128, etc.) Similar equations are used for green and blue color components. Equation (2) can also be written as is illustrated in Equation (2A):
R′(x,y)=Con2+((R(x,y)−Rₘₑₐₙ)*Con2)/R(x,y). (2A)

Contrast modification: Contrast in a digital image is referred to a difference in color values between any two given pixels. Color values at a given pixel are independently computed from Red, Green and Blue components of the given color image. One step is a determination of active range of intensities in each of the colors. Histogram of all color planes (R, G and B) of the input image are computed. These histograms are used to compute a minimum intensity such that, starting from lowest intensity, cumulative pixels up to minimum intensity is equal to about 2% of total pixels in the image. The active range is mapped to a pre-determined range (e.g., zero, 255). All pixels with value less than minimum intensity are also made zero.

Identification of Gland Components. A pathologist typically manually identifies three major gland components in any given tissue bit, epithelial, stromal and luminal cells. Luminal cells are of a different nature and exist in a layer of epithelial cells that line the lumens of prostate glands and ducts. Luminal cells typically have a cuboidal to columnar shape. Functionally these cells express the enzymes that are the main secretion product of the prostate lining epithelial cells, stromal cells and lymphocytes. Lumen cells are typically of different intensity, shape and architecture. Stroma and cytoplasm are also present in the various tissue areas. Cytoplasm present in between lining cells and lumen has significance compared to cytoplasm present in other parts of tissue image.

A Lumen component is segmented by computing as a gray scale histogram and mean and standard and deviation of a digital image. Pixels are segmented with Equation (3).
Lumen(White Pixels)=ConL−Standard Deviation, (3)
wherein ConL is a constant (e.g., 255, etc.). Cells are segmented by calculating the Mean and Standard. Deviation of selected Blue pixels from the input image and also with Hue, Saturation, Intensity values (HSI Model). Segmented cells are classified as lining (Closed) and Remote Cells.

In one embodiment, individual pixel values in a HSI model are calculated from the respective Red, Green and Blue pixel values. Blue pixels are segmented based on relation between blue component, red component in pixel value. That is, pixels with blue plane value less than red plane value, and green plane value less than 200 and intensity value in HSI model less than 240 are considered as potential pixels on cell. Mean and standard deviation of segmented pixels in Blue plane are computed. Potential pixels on cell are re-segmented based on the condition, hue value of pixel greater than 30 and blue plane pixel value less than (e.g., mean-standard deviation) of all potential cell pixels in Blue plane.

In one embodiment, a total of seven different features are extracted from digital image. However, the present invention is not limited to this embodiment and more or fewer features can also be used to practice the invention. The seven features include, but are not limited to,

Number of Glands in the Image.

Average Lumen area.

Std. Deviation of Lumen area.

Std. Deviation of Gland size.

Distance between the Glands.

Stromal area between the Glands.

Shape of Glands(Circularity/Elongation)

It is observed that extraction of above features is not accurate in the presence of lumen part in the digital image. Therefore lumen part is treated separate and cells and cytoplasm are treated separately.

Glands in prostate tissue bit appear in varying shapes, intensities and architecture. There is need to differentiate between lumen glands, non-lumen glands. Lumen glands require further analysis to obtain features. It is observed that there is need to dilate lumen part into tissue such that one could fill the gap between lining cells surrounding a lumen. Lumen pixels are dilated conditional in all eight directions, maximum of 5. Next a number of cell pixels around a lumen are counted. This is done by counting all cell pixels at a distance not more than five pixels from the nearest lumen boundary. A percentage of cell pixels around a lumen are calculated by taking the percentage of cell pixels around a lumen over lumen perimeter. This percentage is used to determine if the lumen is to be processed further or not. If this percentage is more than 70, it means that there are sufficient number of lining cells around a lumen and it should be identified as gland. If this percentage is less than PI (e.g., 70%), then there are few lining cells around the lumen, and this is ignored from further analysis.

A detailed analysis of cells within lining portion of a lumen gland is carried out to differentiate between epithelial lining cells, lymphocytes and stromal cells. First, a first ratio1 is computed as illustrated in Equation (4).

$$ratio 1 = \frac{Lumen Gland Size .}{Surrounding Cell Area} \qquad ( 4 )$$

Epithelial cells and lymphocytes are separated based on size of the cell and ratio1. If ratio1 is more than 20 and the cell size is less than 7000 pixels, then the cell is identified as epithelial lining cells. Otherwise, size of the cell will be used to differentiate between lymph cells connected to epithelial cell based on size. If the cell size is more than 30, then it is classified as lymph cell connected to an epithelial lining cells. All other cells with size less than 30 pixels are rejected. Lumen from epithelial cells periphery is searched in 4 directions with cytoplasm at maximum 20 pixels (e.g., 5-6 cells width). The gaps between epithelial cells cytoplasm and lumen is filled.

Non Lumen Gland Components are analyzed in three steps. Lumen Gland areas are removed from the cell image. Epithelial cells connected to edge lumen are segmented. All other cells as are displayed as non lumen gland epithelial cells.

At Step 36, selected ones of the remaining parts in the area of interest of image is identified as stroma and Cytoplasm. First high intensity pixels from the input image are removed. A pixel is identified as high intensity pixel if intensity parameter in HSI model is more than 180 and pixel value in green plane is more than 230. Next, pixels belonging to cells and lumen are removed from the input image. These pixels are identified based on the difference in pixel values between red plane and blue plane and hue value. In the current invention a pixel is considered for deletion if the hue value is in the range 30 and 95, and one of the following two conditions are satisfied. Equation (5) illustrates cell segmentation. However, the present invention is not limited to this embodiment and other conditions can also be used to practice the invention.
0<[(R(x,y)−B(x,y))×Const1/R(x,y)]<Cond1 (5)
0<[(B(x,y)−R(x,y))×Const1/B(x,y)]<Cond2,
where R(x,y), B(x,y) indicates pixel values in red plane and blue plane respectively, Const1 is a first constant (e.g., 100, etc.), Cond1 is a first condition value (e.g., 5, etc.) and Cond2 is a second condition value (e.g., 200, etc.).

Segmented cells consist of lining cells around gland lumen, isolated cells in stromal area, stromal cells, lymphocytes and epithelial cells. It is necessary to filter some of these cells for a more accurate interpretation of the tissue bit. A Gaussian blur is applied on these segmented cell images to eliminate high frequency noise or variations due to vesicular of cells. In one embodiment, a Gaussian operator with a value of 3.0 for Sigma is used. A Canny edge detection operator is used to determine boundary of each cell in Gaussian blurred segmented cell image. In the current invention, low threshold of 0.2 and high threshold of 0.6 is used in detecting edges by Canny edge detection. However, the present invention is not limited to these values and other values can also be used to practice the invention.

Isolated cells in stromal area are detected by measuring distance between a cell and its nearest neighboring cell. If this distance is very large compared to cells size then we consider the cell under consideration is isolated in stromal area and filter. At the magnification level used for analysis of tissue bits, breaks in chain of lining cells are found. This could be more significant in digital images with low compression ratios used for storage and retrieval. There is need to dilate segmented cell images such that lining cells looks continuous.

It is known that for comprehensive analysis of prostate tissue bit, features from Lumen, Cells as well as cytoplasm/stromal parts of the image are used. A composite image consisting of segmented lumen, cells and cytoplasm is created.

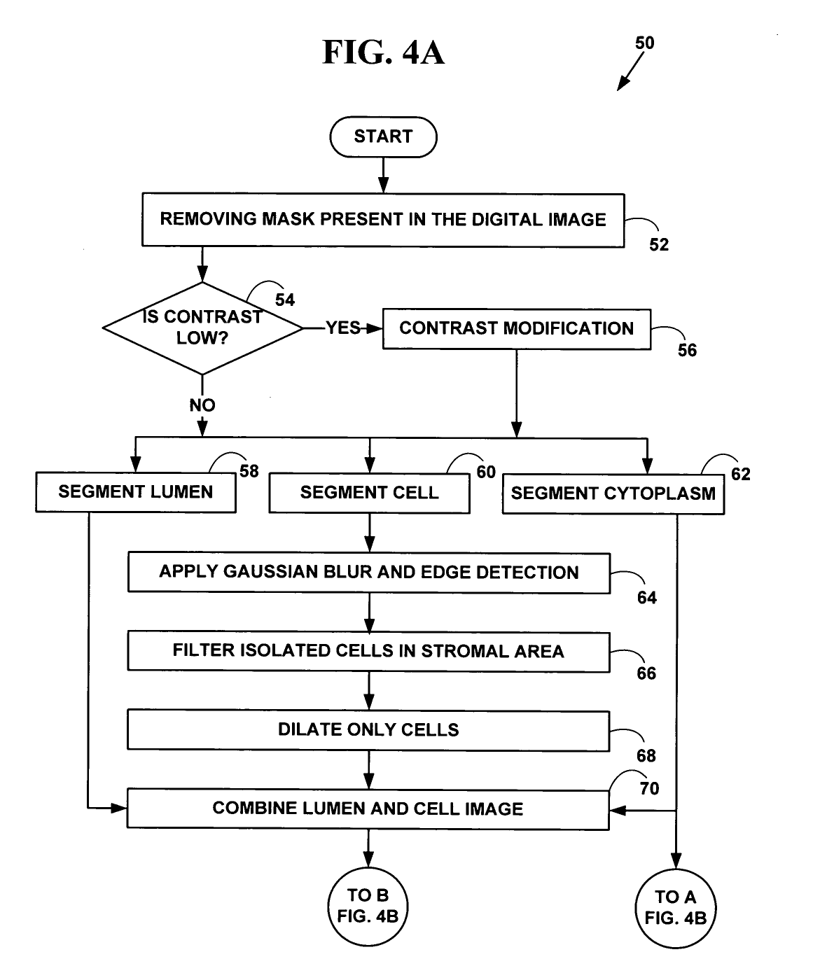

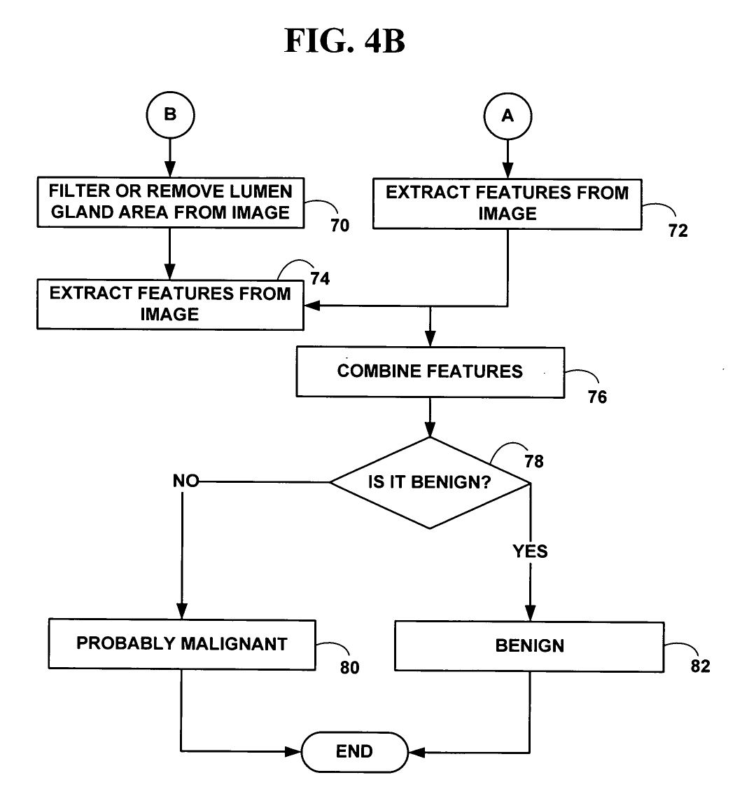

FIGS. 4A and 4B a flow diagram illustrating a Method 50 for removing color masks or artifacts in a digital image.

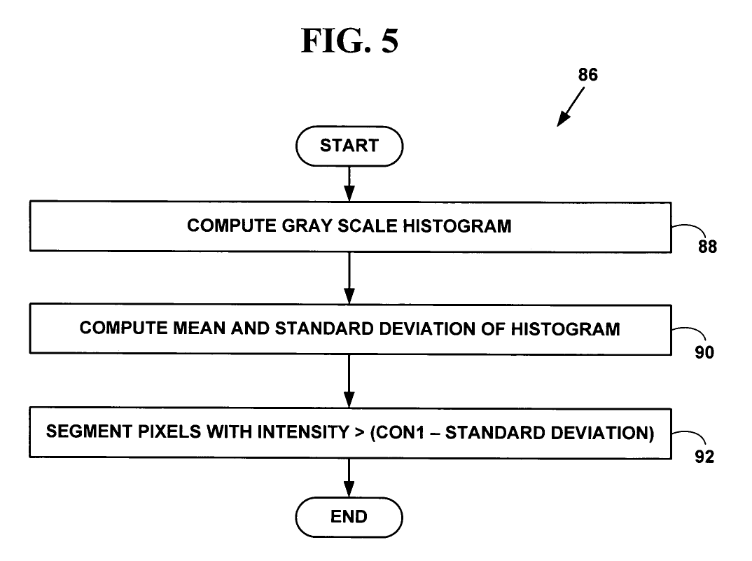

FIG. 5 is a flow diagram illustrating a Method 70 for lumen segmentation in a digital image.

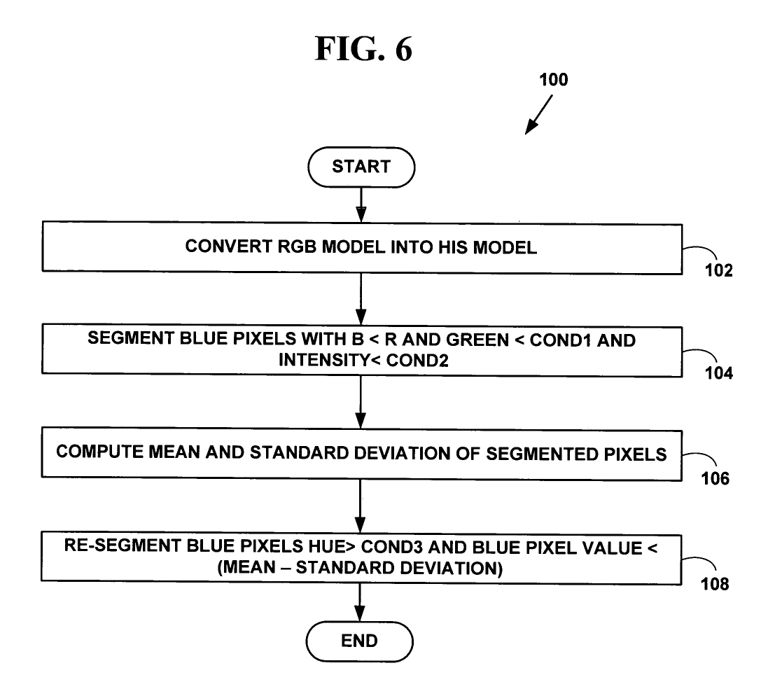

FIG. 6 is a flow diagram illustrating a Method 100 for cell segmentation in a digital image.

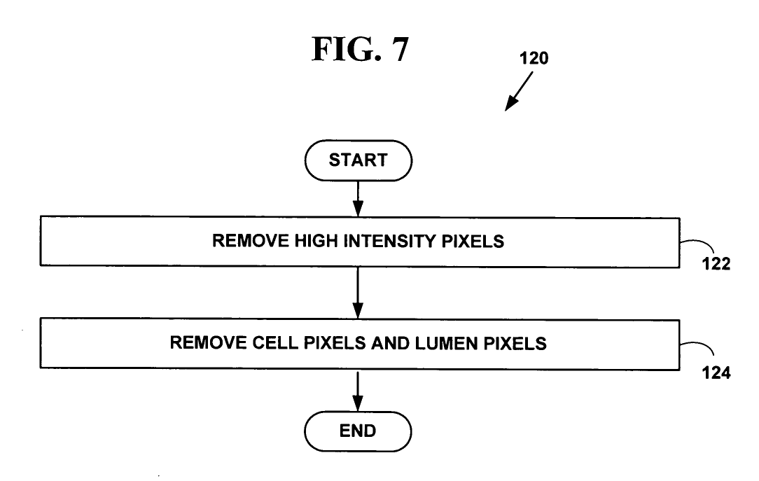

FIG. 7 is a flow diagram illustrating a Method 120 for cytoplasmic segmentation in a digital image.

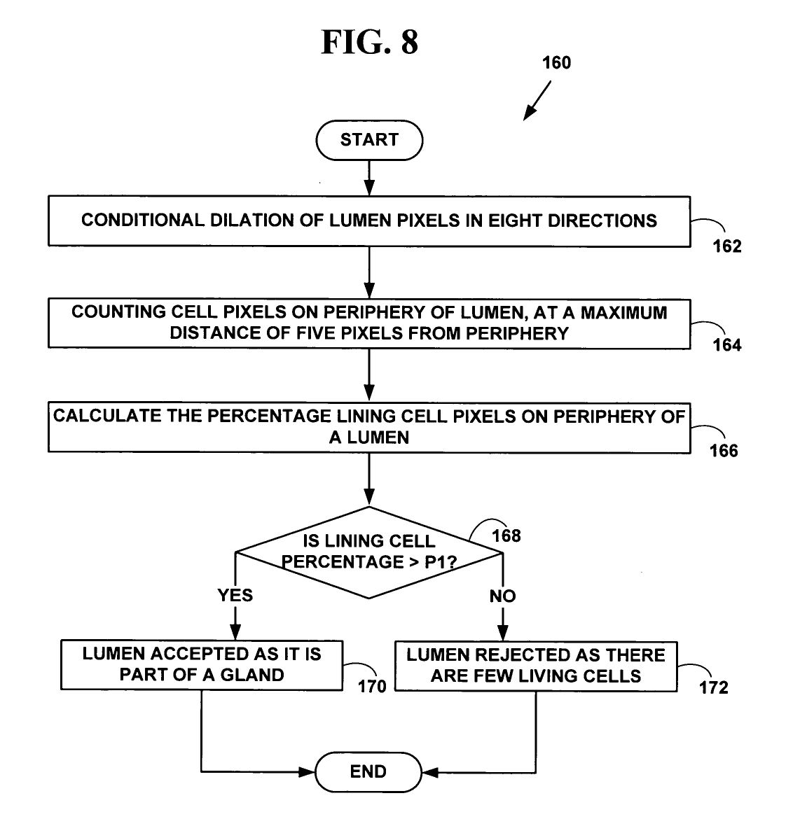

FIG. 8 is a flow diagram illustrating a Method 160 for segmentation lumen gland in a digital image.

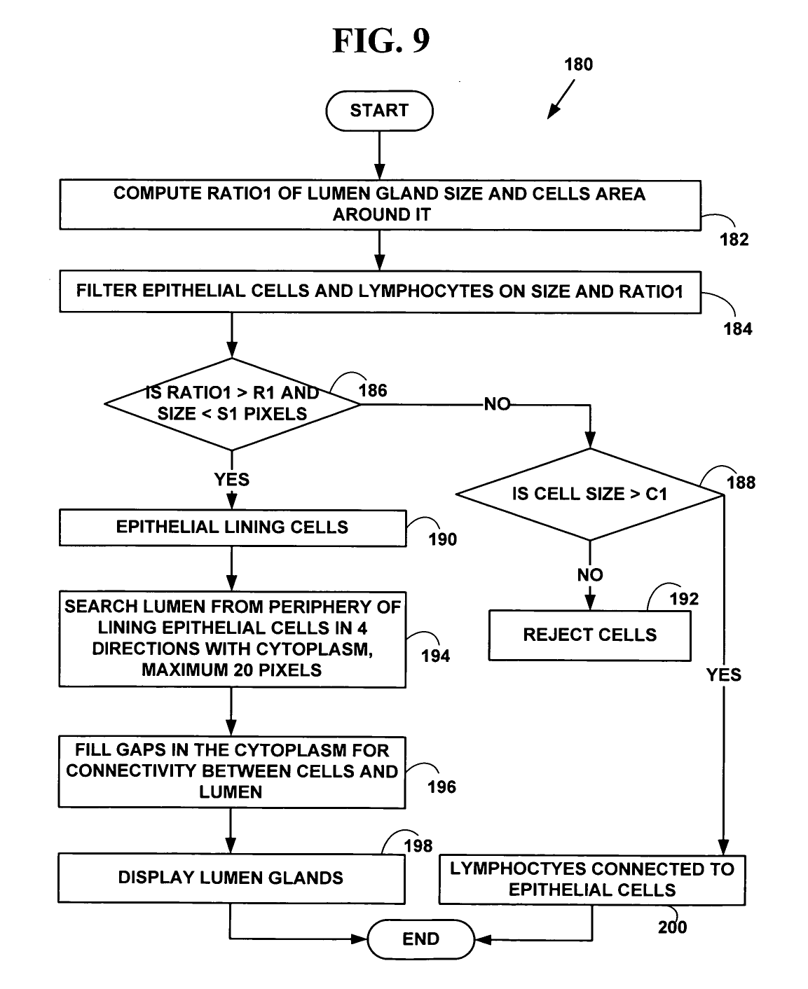

FIG. 9 is a flow diagram illustrating a Method 180 for segmentation lumen gland in a digital image.

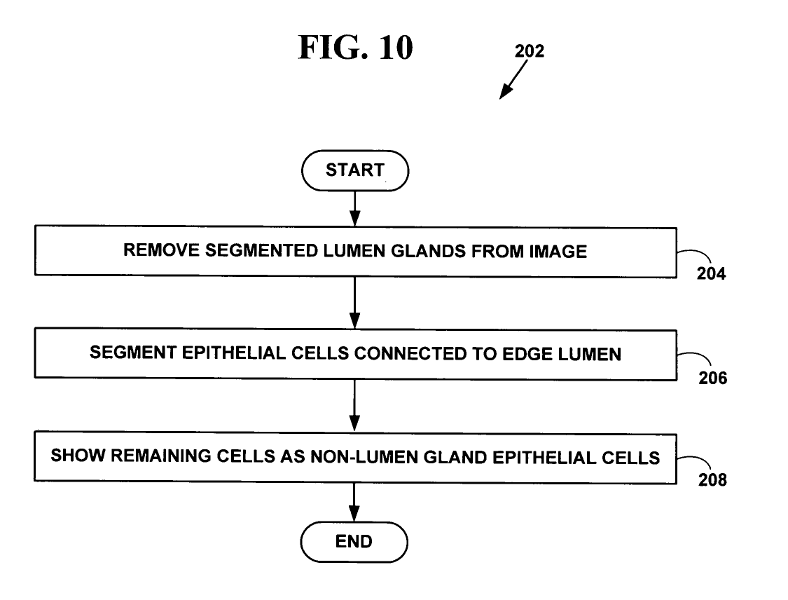

FIG. 10 is a flow diagram illustrating a Method 202 for segmentation non-lumen glands in a digital image.

FIGS. 4-10 illustrate additional details for methods and embodiments used at Steps 34 and 36. However, the present invention is not limited to these embodiments and other embodiments can be used practice the invention at Steps 34 and 36.

Returning to FIG. 3 at Step 38, remaining features are automatically classified using a medical classification scheme. In one embodiment, A Gleason grade and score is used.

Identify and Classify Gleason Grade: A combination of the Weighted Features is used to Classify the Input Images from Benign and Malignant. Classification of the Malignant Tissues into Gleason Grades (Primary and Secondary) is done by automatically combining clinical findings to decide malignancy.

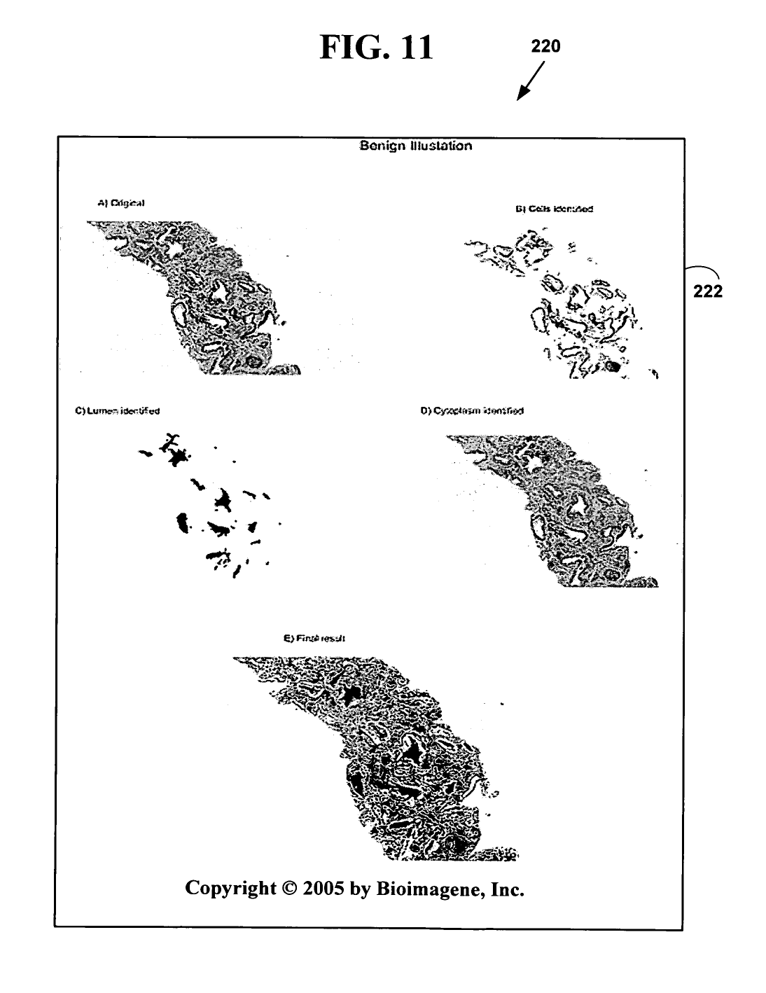

FIG. 11 is a block diagram 220 illustrating plural digital images 222 corresponding to a benign tissue bit. FIG. 11 illustrates: (A) original image; (B) illustrates cells identified, marked in pink color; (C) illustrates lumen identified marked with a red color; (D) illustrates cytoplasm identified with a green color; (E) illustrates a final result after automated processing by Method 32. In (E) lumen is marked red, yellow indicates epithelial cells, green indicates cytoplasm, cyan indicates non-lumen epithelial cells and lymphocytes.

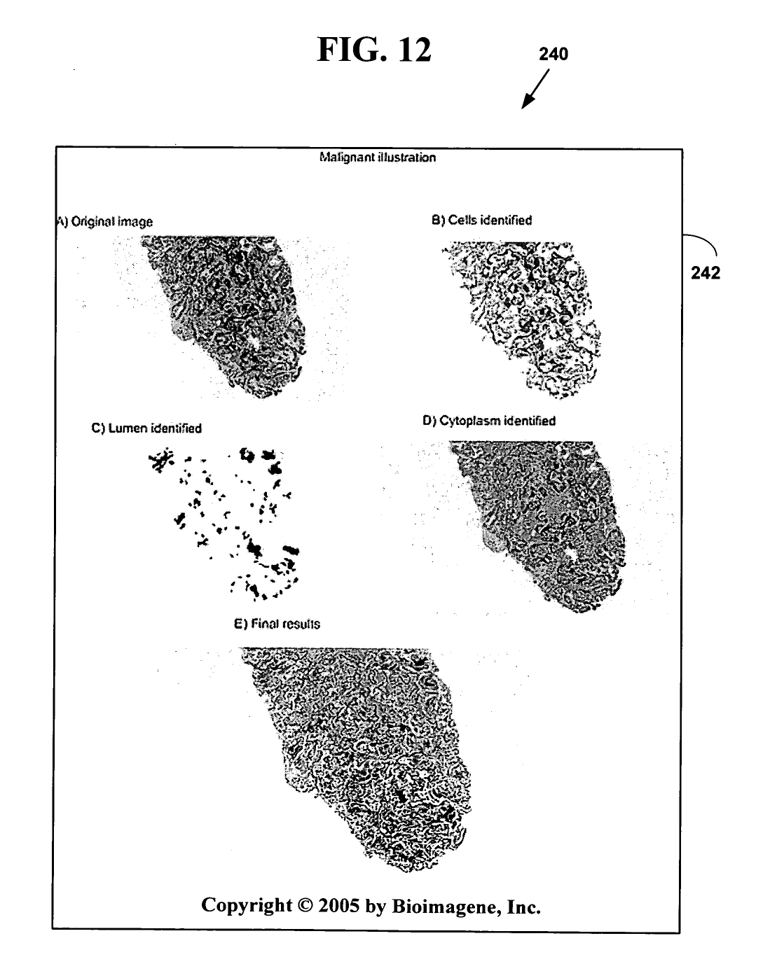

FIG. 12 is a block diagram 240 illustrating plural digital images 242 corresponding to a malignant tissue bit. FIG. 12 illustrates (A) an original image; (B) illustrates cells identified, marked in pink color; (C) illustrates lumen identified with red color; (D) illustrates cytoplasm identified with a green color and (E) illustrates a final result after automated processing by Method 32. In (E) yellow indicates epithelial cells, green indicates cytoplasm, cyan color indicates non-lumen epithelial cells and lymphocytes.

Automated Artificial Neural Networks

Artificial neural networks are discussed extensively in prior art. There are several research papers, products using artificial neural networks in prior art. Artificial neural systems can be considered as simplified mathematical models of brain-like systems and they function as parallel distributed computing networks. However, in contrast to conventional computers, which are programmed to perform specific task, most neural networks must be taught, or trained. Neural networks can learn new associations, new functional dependencies and new patterns to detect and diagnose human prostrate cancers.

Role of Neural Networks in Determining an Automated Gleason Score

Automatically detecting the presence of malignancy in a prostate tissue section and then classifying the detected malignant tissue into a Gleason score plays a significant role in prostate cancer detection and treatment.

Pathologists use number of properties in deciding the nature of malignancy, clinical findings and patient data. Many of these properties are not having a rigid definition. Many a times pathologists give experience based decisions. An automated system behaves in a manner similar to human pathologist and at the same time produce consistent decisions needs to acquire and retain the experience and expertise of human pathologists. Neural network provides a model suitable for capturing such experience and expertise.

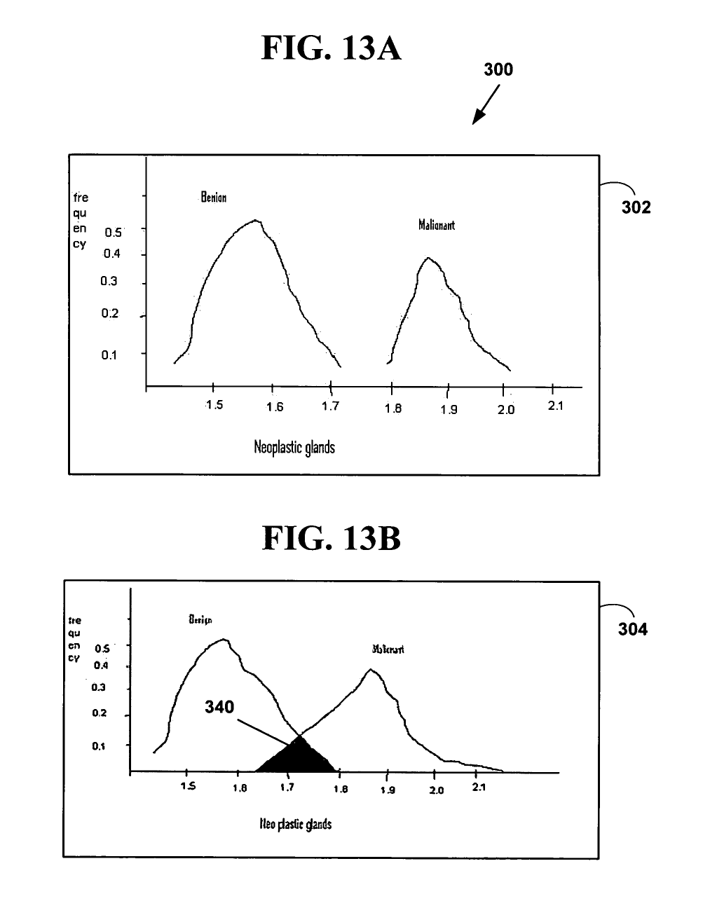

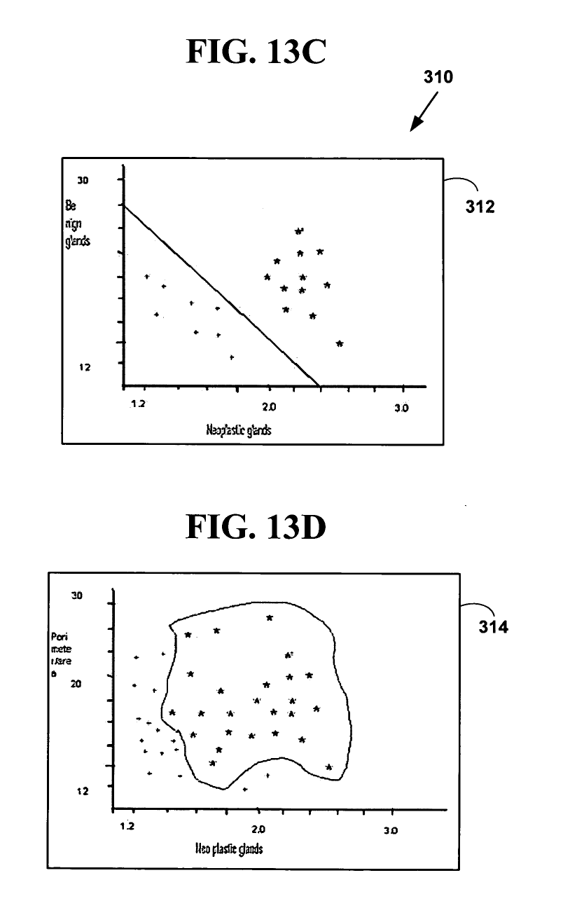

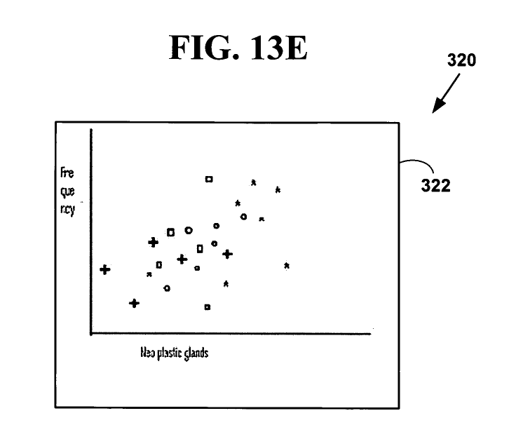

FIG. 13A is a block diagram 300 illustrating a distribution of frequency of neo-plastic glands present in a tissue bit 302. If the average number of neo-plastic glands is always greater than 1.75 for malignant tissue bits and the average number of neo-plastic glands is less than 1.75 for benign tissue bits, a simple classifier based on the average number of neo-plastic glands in a tissue bit can be built. However in reality, a clear separation in the frequency of distribution of neo-plastic glands may not be possible. Generally there is an overlapping distribution 340 as illustrated in FIG. 13(B).

That is, there might be some malignant tissue bits with average number of neo-plastic gland in the range 1.65 to 1.75 and there could be some benign tissue bits with average neo-plastic glands in the range 1.75 to 1.8. FIG. 13B is a block diagram 304 indicating an error 340 in decision process. An incorrect classification is likely if an average number of neo-plastic glands is in the range 1.65-1.8. A benign tissue bit might be classified as malignant or a malignant tissue bit might be classified as benign tissue.

A variety of techniques are used to process data having the distribution pattern shown illustrating in FIG. 13C. FIG. 13C is a block diagram 310 illustrating clustering 312. Clustering and neural networks are two prominent techniques used. Clustering technique is a statistical approach to segregate the given data elements into the required number of classes. Computational complexity increases with the number of classes and the closeness or overlapping regions of clusters. FIG. 13D is a block diagram 314 illustrating another clustering 314. While the clustering might work well for data in FIG. 13D, it fails to resolve the confusion if the classes have no clear boundaries between classes.

FIG. 13E is a block diagram 320 illustrating analysis of clustering 322. Analysis of data illustrated in FIG. 13E cannot be clustered into different classes giving a Gleason score using the two features described above. Normally researchers follow one of the following two approaches to improve the classifier performance.
Identify additional features or a different set of features that could provide well differentiated classes. This identification becomes subjective and also sensitive to the set of examples used for testing.
Identify a set of features that appear to be having variation amongst the classes. Design a neural network and train the neural network on the extreme cases of data distribution.

In one embodiment, a neural network is used to improving some of the problems presented by automated processing of digital images including clustering.

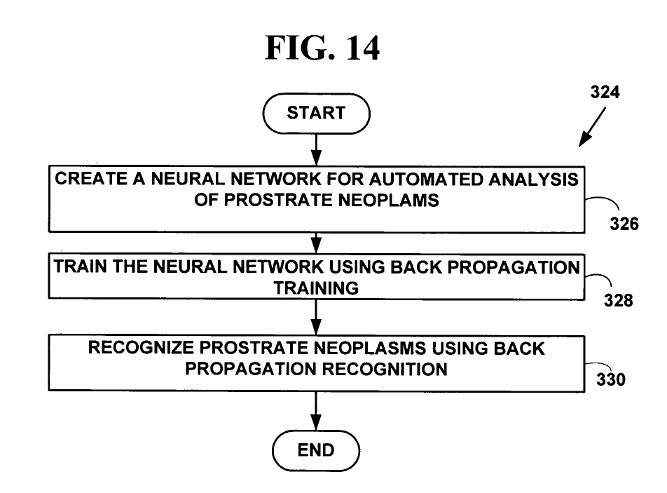

FIG. 14 is a flow diagram illustrating Method 324 for automated digital image analysis of prostrate neoplasms using morphologic patterns. At Step 326, a neural network is created for automated analysis of prostrate neoplasms. At Step 328, the neural network is trained using back propagation training. At Step 330, prostrate neoplasms are recognized using back propagation recognition on the neural network.

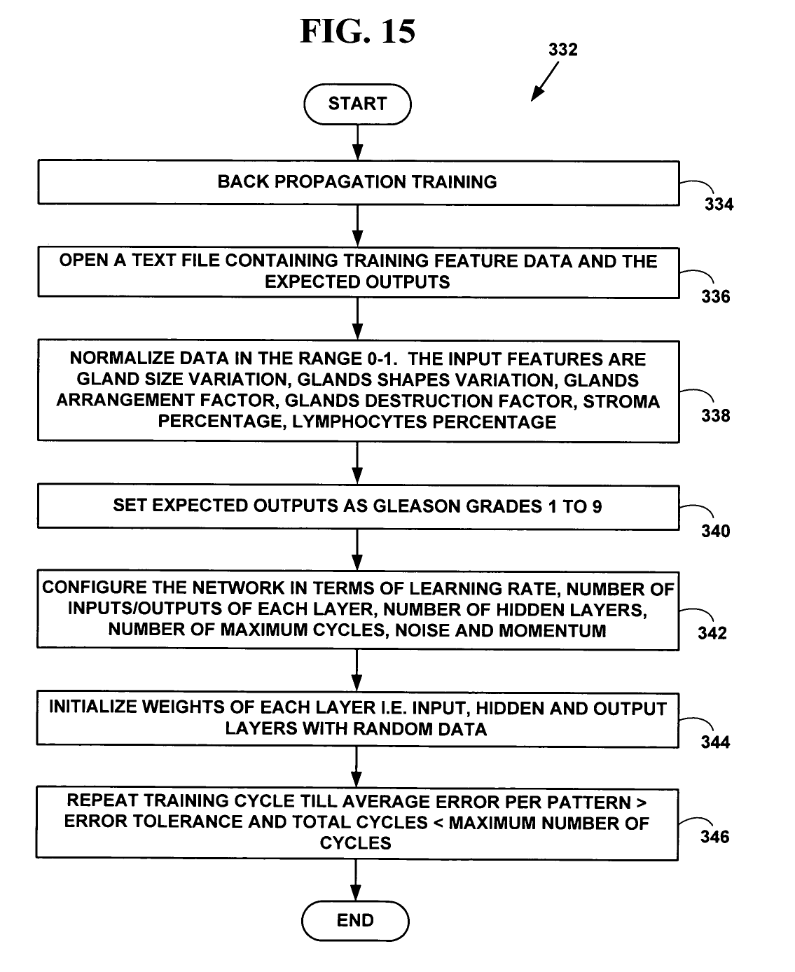

FIG. 15 is a flow diagram illustrating a Method 332 for back propagation training. In one embodiment, this method is used at Step 328 of Method 324. However, the present invention is not limited to this embodiment and other embodiments can be used practice the invention.

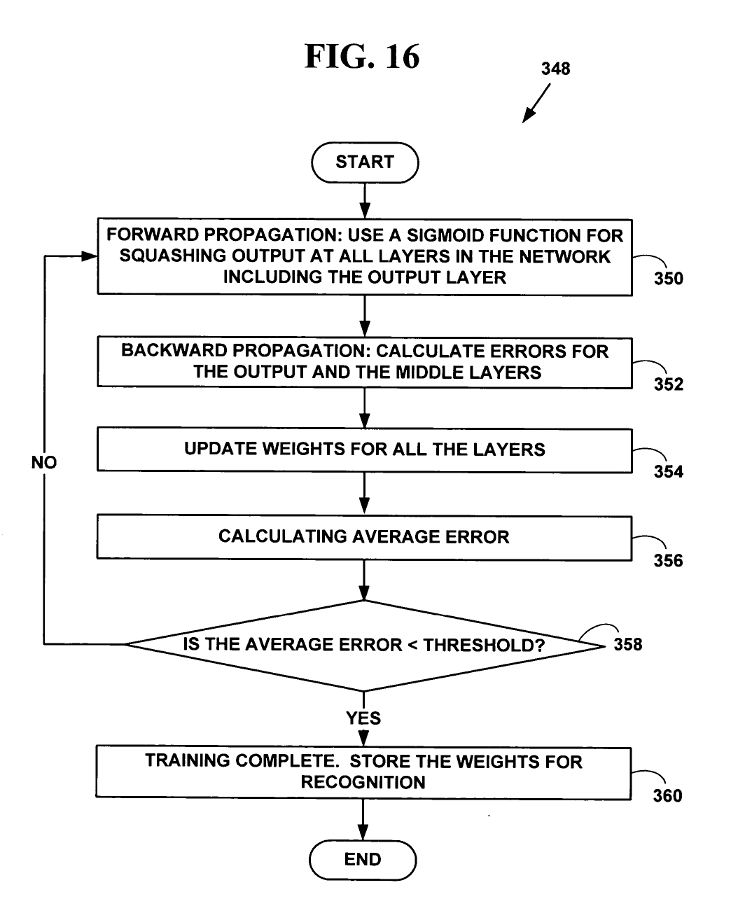

FIG. 16 is a flow diagram illustrating a Method 348 for a training cycle. In one embodiment, this method is used at Step 328 of Method 324. However, the present invention is not limited to this embodiment and other embodiments can be used practice the invention

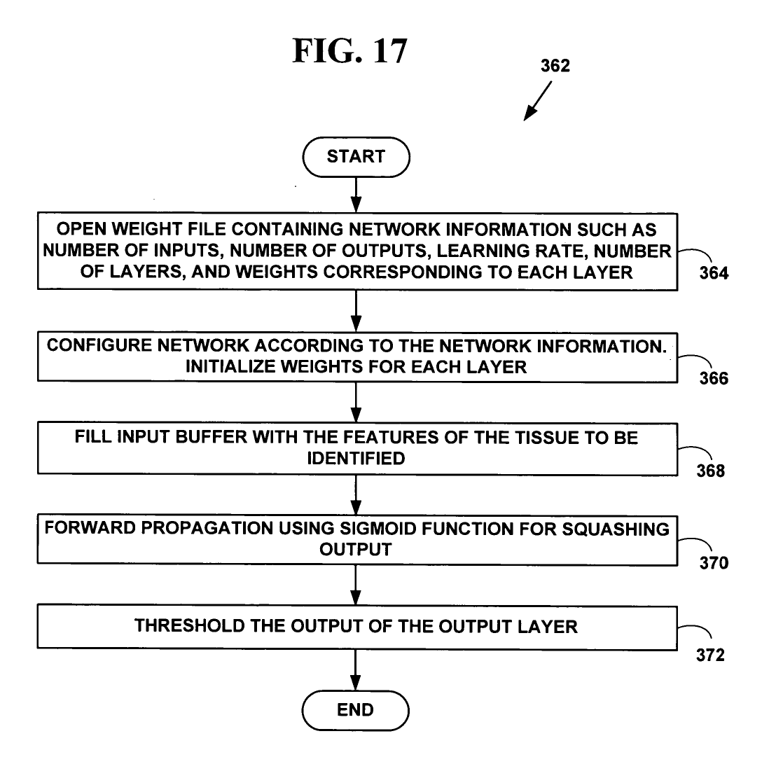

FIG. 17 is a flow diagram illustrating a Method 362 for back propagation recognition. In one embodiment, this method is used at Step 330 of Method 324. However, the present invention is not limited to this embodiment and other embodiments can be used practice the invention.

It is known that a successful neural network solution to a problem depends on one or more of the following factors.
Independent feature set that provides variation in feature values across the different classes.
Good training set to establish boundaries in a hyperspace that could classify data successfully. Training set should include extreme cases in all classes.
A training method/strategy that does not converge on local minima while training.

In one embodiment, a Back propagation training includes, but is not limited to, the following steps:

Step 1: A text file containing training feature data and the expected outputs is opened. The input features are Gland size variation, Glands shapes variation, Glands arrangement factor, Glands destruction factor, Stroma percentage, Lymphocytes percentage. Expected outputs are Gleason grades 1 to 9.

Step 2: The feature data is normalized to be in the range 0 to 1.

Step 3: Network is configured in terms of learning rate, number of inputs/outputs of each layer, number of hidden layers, number of maximum cycles, noise and momentum.

Step 4: Weights of each layer is initialized with random data (i.e. input, hidden and output layers).

Step 5: Repeat forward propagation till the average error is less than specified error tolerance. Terminate repetition if the number of cycles exceeds specified maximum. The forward propagation is done for all layers in the network including the output layer. A sigmoid function is used for squashing output.

Step 6: Errors for the output and the middle layers is calculated (i.e., back propagation).

Step 7: Average error per pattern is calculated.

Step 8: Forward propagation is repeated with modified weights till average error is less than error tolerance or the number of cycles exceeds maximum. Training is successful if one of these conditions are satisfied.

Step 9: If the training is successful, save weights of all the layers into the weight file.

In one embodiment, Back propagation recognition includes, but is not limited to the following steps.

Step 1: Open weight file containing network information such as number of inputs, number of outputs, learning rate, number of layers, and weights corresponding to each layer.

Step 2: Configure network according to the network information. Initialize weights for each layer.

Step 3: Fill input buffer with the features of the tissue bit to be identified.

Step 4: Forward Propagation using sigmoid function for squashing output. This is done for all layers in the network including the output layer but excluding the input layer.

Step 5: Get the output of the output layer. Threshold this output using a simple threshold to arrive at a decision.

However, the present invention is not limited to the steps described for forward and backward propagation and more, fewer or other steps can also be used for Forward and Backward propagation for automated prostrate tissue sample analysis.

Fuzzy logic is discussed extensively in prior art. Fuzzy logic provides an inference morphology that enables approximate human reasoning capabilities to be applied to knowledge-based systems. The theory of fuzzy logic provides a mathematical strength to capture the uncertainties associated with human cognitive processes, such as thinking and reasoning.

Some of the essential characteristics of fuzzy logic relate to the following:

In fuzzy logic, exact reasoning is viewed as a limiting case of approximate reasoning.
In fuzzy logic, everything is a matter of degree.
In fuzzy logic, knowledge is interpreted a collection of elastic or, equivalently, fuzzy constraint on a collection of variables.
Inference is viewed as a process of propagation of elastic constraints.
Any logical system can be fuzzified.

There are two main characteristics of fuzzy systems that give them better performance for specific applications.
Fuzzy systems are suitable for uncertain or approximate reasoning, especially for the system with a mathematical model that is difficult to derive.
Fuzzy logic allows decision making with estimated values under incomplete or uncertain information.
   Fuzzy logic is also used automated prostrate tissue sample analysis.

The methods and system described herein is used for, but not limited to: (1) automated screening of prostate needle biopsy specimens by automatically segregating cases/images of prostate needle biopsies into “Benign”, “Borderline”, and “Malignant” categories. The “Borderline” cases will go through automated and/or manual peer review, after which those digital images will be either classified as “Benign” or as “Malignant.” “Malignant” cases will be processed for getting Gleason”s grade and score; and automated diagnosis of prostatectomy specimens: in some cases, where diagnosis of prostatic enlargement has already be made out, either at some other laboratory or hospital, and where only prostatic tissue specimens are received, the images will be automatically processed in a same manner like that of a manual screening approach, and diagnosis will be made on “Benign”, “Borderline”, or “Malignant” condition; and if diagnosed as “Malignant”, then Gleason grade and score will also be added to the “final diagnosis”.

The present invention is implemented in software. The invention may be also be implemented in firmware, hardware, or a combination thereof. However, there is no special hardware or software required to use the proposed invention.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “imeans” is not so intended.

Therefore, all embodiments that come within the scope and spirit of the following claims and equivalents thereto are claimed as the invention.

We claim:

1. A method for automated digital image analysis of prostrate neoplasms using morphologic patterns, comprising:
extracting a plurality of features from a digital image of a prostrate tissue sample to which a chemical compound has been applied;
automatically removing selected ones of the plurality of extracted features from further consideration; and
automatically classifying remaining features in the plurality of extracted features using a medical classification scheme to determine a medical classification for the prostrate tissue sample.

2. The method of claim 1 further comprising a computer readable medium have stored therein instructions for causing one or more processors to execute the steps of the method.

3. The method of claim 1 wherein the chemical compounds includes Haematoxylin and Eosin (H/E) stain.

4. The method of claim 1 wherein the plurality of extracted features include size, shape, arrangement, destruction, stroma area, cytoplasm area or Lymphocytes presence.

5. The method of claim 1 wherein the step of automatically removing selected ones of the plurality of features from further consideration includes removing selected ones of the plurality features of an intermediate nature and non-malignant features.

6. The method of claim 5 wherein the step of automatically removing selected ones of the plurality of features from further consideration includes removing areas of cyotoplasm and stroma from the prostrate tissue sample.

7. The method of claim 1 wherein the medical classification scheme includes a Gleason's grade and score.

8. The method of claim 1 wherein the medical classification scheme includes a medical classification for a human prostrate cancer.

9. The method of claim 1 wherein the medical conclusion is benign, borderline, or malignant for the prostrate tissue sample.

10. The method of claim 1 wherein the step of extracting a plurality of features from a digital image includes adjusting a contrast of the digital image or removing a mask or artifact from the digital image.

11. The method of claim 1 wherein the extracting a plurality of features includes segmenting lumen pixels by computing a gray scale histogram; computing a mean and standard and deviation of the gray scale histogram; and segmenting lumen pixels with an intensity greater than a first constant minus the standard deviation.

12. The method of claim 1 wherein the step of automatically removing selected ones of the plurality of extracted features from further consideration includes segmenting cell pixels by converting a Red-Green-Blue (RGB) model of the digital image into a Hue, Saturation, Intensity (HIS) model; segmenting blue pixels with a blue pixel value less than a red pixel value and a green pixel value less than a first constant and an intensity less than a second constant; computing a mean and standard deviation of any segmented pixels; and re-segmenting blue pixels with a hue greater than a third constant and a blue pixel value less than the mean minus the standard deviation.

13. The method of claim 1 wherein the step of automatically removing selected ones of the plurality of extracted features from further consideration includes segmenting cytoplasm pixels by removing high intensity pixels; and removing cell pixels and lumen pixels.

14. The method of claim 1 wherein prostrate tissue sample is a needle biopsy tissue sample.

15. The method of claim 1 wherein the step of extracting a plurality of features from a digital image includes extracting a number of glands, an average lumen area, a standard deviation of the lumen area, a standard deviation of the gland size, a distance between glands, a stromal area between glands and a shape of the glands including circularity and elongation.

16. A method for automated digital image analysis of prostrate neoplasms using morphologic patterns, comprising:
creating a neural network for automated analysis of prostrate neoplams;
training the neural network using back propagation training; and
recognizing prostrate neoplasms using back propagation recognition.

17. The method of claim 16 further comprising a computer readable medium have stored therein instructions for causing one or more processors to execute the steps of the method.

18. The method of claim 16 wherein the step of training the neural network using back propagation includes training the neural network with data including gland size variation, gland shapes variation, gland arrangement factors, gland destruction factors, Stroma percentage and Lymphocytes percentage.

19. The method of claim 16 wherein the recognizing prostrate neoplasms includes a Gleason grade from one to nine for a selected prostrate neoplasm.

20. An automated digital image analysis system for prostrate neoplasms, comprising in combination:
means for extracting a plurality of features from a digital image of a prostrate tissue sample to which a chemical compound has been applied;
means for automatically removing selected ones of the plurality of extracted features from further consideration; and
means for automatically classifying remaining features in the plurality of extracted features using a medical classification scheme to determine a medical classification for the prostrate tissue sample.

21. The system of claim 20 wherein the medical classification scheme includes a Gleason's grade and score for a human prostrate tissue sample.
